(19) United States
(12) Patent Application Publication
(10) Pub. No.: US 2007/0194615 A1
(43) Pub. Date: Aug. 23, 2007

(54) Guide Device For Guiding An Adjuster Element On An Adjuster Device For Motor Vehicles

(76) Inventor: Matthias Fischer, Kronach (DE)

Correspondence Address: CHRISTIE, PARKER & HALE, LLP, PO BOX 7068, PASADENA, CA, 91109-7068, US

(21) Appl. No.: 10/593,431

(22) PCT Filed: Mar. 7, 2005
(86) PCT No.: PCT/DE05/00413

§ 371 Date: Sep. 18, 2006

(30) Foreign Application Priority Data
Mar. 18, 2004 (DE) 20 2004 004 615.6

(51) Int. Cl. B60N 2/02

(52) U.S. Cl. 297/354.12; 297/378.13

(57) ABSTRACT

A guide device for guiding an adjuster element on an adjuster device for motor vehicles, comprising a guide track, along which the adjuster element can be moved, a guide section of the adjuster element, via which the adjuster element is guided in the guide track, and locking means for locking the guide section in the guide track in at least two mutually spaced adjustment positions. According to the invention the locking means comprise a movably mounted locking element having at least two mutually spaced locking sections, and in that the locking element can be brought into a locking position in which it, with one locking section, can block the guide section in a first adjustment position and, with the other locking section, can block the guide section in a second adjustment position.

### CROSS-REFERENCE TO A RELATED APPLICATION

This application is a National Phase Patent Application of International Patent Application Number PCT/DE2005/000413, filed on Mar. 7, 2005, which claims priority of German Patent Application Number 20 2004 004 615.6, filed on Mar. 18, 2004.

### BACKGROUND

The invention relates to a guide device for guiding an adjuster element on an adjuster device for motor vehicles.

A guide device of this type comprises a guide track, in which the adjuster element engages with a guide section so that it can be moved along the guide track, and locking means for locking the guide section in the guide track in at least two different adjustment positions.

Such a guide device can be used, in particular, in adjuster devices for motor vehicle seats, wherein the adjuster element is formed by a pivotably mounted adjuster lever which is guided, with one lever end, in a connecting link forming the guide track. For the adjustment of a seat part, the adjuster lever can be pivoted into different angular positions corresponding, respectively, to a defined adjustment position of the guide section of the adjuster lever, which guide section is guided in the connecting link. In each of these adjustment positions, the guide section of the adjuster lever can be locked in the assigned connecting link, so that the adjuster lever is consequently secured in a defined position which in turn corresponds to a certain adjustment of a seat part coupled to the adjuster lever, such as, for example, a seat support which is displaceable by means of the adjuster lever in order to widen the loading space, or a backrest, adjustable by means of the lever, or a correspondingly adjustable headrest.

### SUMMARY

The invention is based on the problem of providing a guide device of the type stated in the introduction, which, with simple means, allows the adjuster element to be locked in different adjustment positions.

The locking means which serve to lock the guide section of the adjuster element, for example a (pivotably mounted) adjuster lever, have a movably mounted locking element having two mutually spaced locking sections, the locking element being able to be brought into a locking position in which it, with one locking section, can block the guide section of the adjuster lever in a first adjustment position and, with the other locking section, can block the guide section of the adjuster element in a second adjustment position. This means that an individual locking element in a defined locking position can lock the guide section of the adjuster element guided on the guide device both when the guide section is in a first adjustment position and when the guide section is in a second, different adjustment position which is distanced from the first adjustment position along the guide track.

That is to say, regardless of whether the guide section is currently in the first or the second adjustment position, it can respectively be blocked (and thus the adjuster element locked in a defined position) by one locking element being brought into a defined position referred to as the locking position. In this locking position, it blocks the guide section with a first locking section when the guide section is in the first adjustment position and blocks the guide section with a second locking section when the guide section is in the second adjustment position.

The equivalent applies when more than two adjustment positions of the guide section and, consequently, more than two locking sections of the locking element are provided.

Preferably, the locking element can be moved to and fro between a release position and a locking position, wherein, in its release position, it enables (permits) a movement of the adjuster element along the guide track and, in its locking position, prevents a movement of the adjuster element, since the guide section thereof, which is guided on the guide track, is blocked in an adjustment position by an assigned locking section of the locking element.

The locking element can be formed, for example, by a pivotably mounted locking lever, which is movable to and fro between the release position and the locking position. On the other hand, the locking element can be constituted by a longitudinally displaceable locking part, which is displaceable to and fro between the release position and the locking position.

According to a preferred embodiment of the invention, the locking element is elastically pretensioned in the direction of its locking position, so that, in order to reach the release position, the locking element must be moved counter to the elastic pretensioning out of the locking position.

According to an advantageous refinement of the invention, the locking element can be detained in its locking position by means of a secondary locking element, which in turn can be elastically pretensioned in the direction of the position in which it detains the (primary) locking element. This is meant to ensure that forces acting upon the primary locking element cannot lead to this locking element being moved out of the locking position and thereby inadvertently releasing the guide section of the adjuster element, which guide section is to be blocked in an adjustment position.

Preferably, the secondary locking element is here coupled to the primary locking element in such a way that, through movement of the secondary locking element out of the position in which it detains the primary locking element, the primary locking element is at the same time transferred out of its locking position into the release position. In this case, the secondary locking element thus serves not only to detain the primary locking element in the locking position, but simultaneously also as actuating means for transferring the primary locking element out of the locking position into the release position. To this end, the secondary locking element can be driven manually or by servo means, in particular by means of an electric motor.

The detention of the locking element in its locking position by means of an assigned secondary locking element serves, in particular, as a safety locking mechanism should crash forces arise.

Under the action of the elastic means which serve to produce a pretensioning, the locking position of the primary locking element can be automatically resumed as soon as there is no longer any force acting upon the secondary locking element, which force holds the primary locking element in the release position.

The secondary locking element, too, can be configured as a pivotably mounted locking lever and it can cooperate with the primary locking element via a link guide, for the tolerance equalization of the parts involved in the locking (primary and secondary locking element, locking link, guide track of the guide device, etc.) and for the play-free locking of the guide section in the guide track, the secondary locking element being engaged with the primary locking element in the locking position in a play-bound manner (i.e. with play).

Alternatively or in addition to the use of a secondary locking element to detain the primary locking element in its locking position, the primary locking element can be arranged in such a way that, at least in the locking position of the primary locking element, the weight forces acting upon the primary locking element stabilize the locking position, i.e. act in the direction of the locking position and counter to the assumption of the release position.

The guide track which serves to guide the adjuster element can be formed in a simple manner by a guide link, in which the adjuster element movably engages with a guide section configured as a guide pin (e.g. in the form of a stud or bolt).

The two adjustment positions into which the adjuster element can be brought with its guide section can be constituted, for example, by two end positions of the guide track or guide link, in each of the two end positions the guide section respectively being clamped between a lateral rim of the guide link and a locking section of the locking element.

In addition, the locking sections of the locking element are preferably shaped in such a way that the guide section of the adjuster element, in each of the at least two adjustment positions, respectively acts upon the assigned locking section of the locking element in such a way that the locking element tends to remain in the locking position and, with a locking section, to clamp the guide section in place in a play-free manner. For this purpose, the corresponding locking section can be configured, for example, in the style of an eccentric. In particular, therefore, the guide section of the adjuster element, in the respective adjustment position, does not act (via an assigned locking section) in such a way upon the locking element that this would tend to assume the release position.

According to one refinement of the invention, the locking element has at least three locking sections, which serve to lock the guide section of the adjuster element in a respective adjustment position, i.e. in a total of at least three adjustment positions. At least one of the locking sections is here formed by a recess in the locking element, which tapers for the play-free reception of the guide section in the further (third) adjustment position.

Advantageously, the locking element has between its two locking sections a contact contour (connecting the locking sections) (e.g. in the form of an edge), which is supported against the guide section when the locking element is in the release position and the guide section is moved from one adjustment position into another adjustment position, so that the locking element is automatically held in the release position. If the guide section reaches the sought-after adjustment position, then the locking element is automatically transferred, preferably by means of an elastic element, into its locking position in which it detains the guide section with a locking section.

### BRIEF DESCRIPTION OF THE DRAWINGS

Further features and advantages of the invention will become clear in the following description of illustrative embodiments with reference to the figures, in which:

FIG. 1a shows a detailed representation of a first embodiment of a guide device for use in a motor vehicle seat, the adjuster lever to be guided being locked in a first adjustment position;

FIG. 1b shows the guide device from FIG. 1a, during movement of the adjuster lever is moved from the first adjustment position into a second adjustment position;

FIG. 1c shows the guide device from FIG. 1a, the adjuster lever to be guided being detained in a second adjustment position;

FIG. 2 shows a refinement of the guide device from FIG. 2a to 2c, having at total of three adjustment positions;

FIG. 3a shows a modification of the guide device from FIG. 1a, having a displaceable locking element for locking the adjuster lever, the adjuster lever being detained in a first adjustment position;

FIG. 3b shows the guide device from FIG. 3a, during movement of the adjuster lever from the first adjustment position into a second adjustment position;

FIG. 3c shows the guide device from FIG. 3a, the adjuster lever being detained in a second locking position;

FIG. 4 shows a further modification of the guide device from FIG. 1a.

### DETAILED DESCRIPTION

Below, a number of illustrative embodiments of a guide device according to the invention are represented, which serve to guide a pivotably mounted adjuster lever for a seat part of a motor vehicle seat, which, for this purpose, engages with a guide section in a guide link of the guide device. The adjuster lever, when pivoted, is guided via its guide section in the assigned guide link, which results in a defined swivel movement of the adjuster lever and a defined movement of a seat part, coupled hereto, in an adjustment direction x. Such a guide device can serve, for example, to guide an adjuster lever, which, on one hand, is operatively connected in such a way to a backrest of a motor vehicle seat mounted pivotably on a backrest support that it is pivoted when the backrest is tilted forward onto the seat surface of the corresponding vehicle seat, and which, on the other hand, is connected in such a way to the backrest support that, when the adjuster lever is pivoted as a result of the backrest having been tilted forward, the backrest support is moved in the longitudinal direction of the seat (e.g. forward). Hence, in the case of rear seats in motor vehicles, when the backrest is tilted forward onto the seat surface, additional storage space can be made available not only above the backrest, but also behind the vehicle seat (which is simultaneously moved forward when the backrest is tilted forward).

When the backrest is tilted forward onto the seat surface, as previously described, and the backrest is subsequently tilted back into an upright usage position, the guide section of the adjuster lever moves between a first end and a second end of the guide link of the assigned guide device. The guide section, for example in the upright usage position of the backrest, is thus located at a first end of the guide link and, when the backrest is tilted forward, is moved to a second end of the guide link. When the backrest is subsequently set upright again, the guide section is then returned to the first end of the guide link. In each of the two previously described adjustment positions (in accordance with the arrangement of the guide section of the adjuster lever at the first or second end of the guide link), said guide section can respectively be blocked in such a way that the adjuster lever is locked in the corresponding adjustment position (in accordance with a certain position of the seat part to be adjusted with the adjuster lever).

The working of different embodiments of a guide device according to the invention, which working is to be described below, is here regardless of whether the adjuster element guided in the guide link of the guide device is constituted by an adjuster lever, as previously described by way of example, or by some other, for example displaceable, adjuster element.

Motor vehicle seats which, for the creation of storage space, firstly are displaceable in the seat longitudinal direction and secondly allow the backrest to be tilted forward onto the seat surface, and in which a guide device according to the invention would be usable, are described, for example, in German patent applications 102 46 473, 103 06 626, 103 17 238 and 103 18 718, and in German utility model application 203 03 753.

In addition, the guide device according to the invention is quite generally usable in adjuster devices in which an adjuster element is guided in a guide track and is intended to be lockable in at least two adjustment positions which are distanced apart along the guide track.

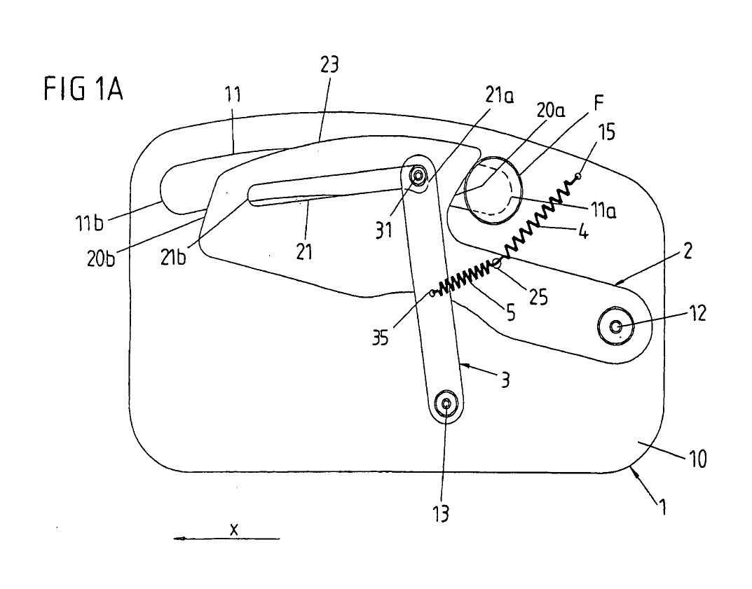

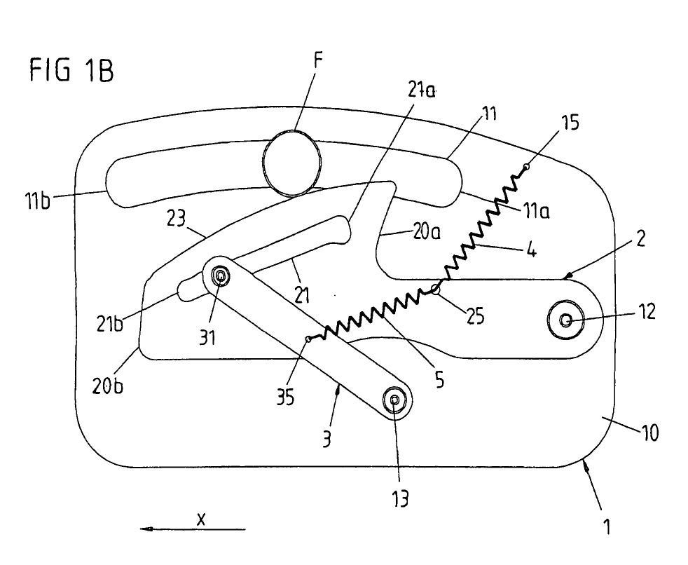

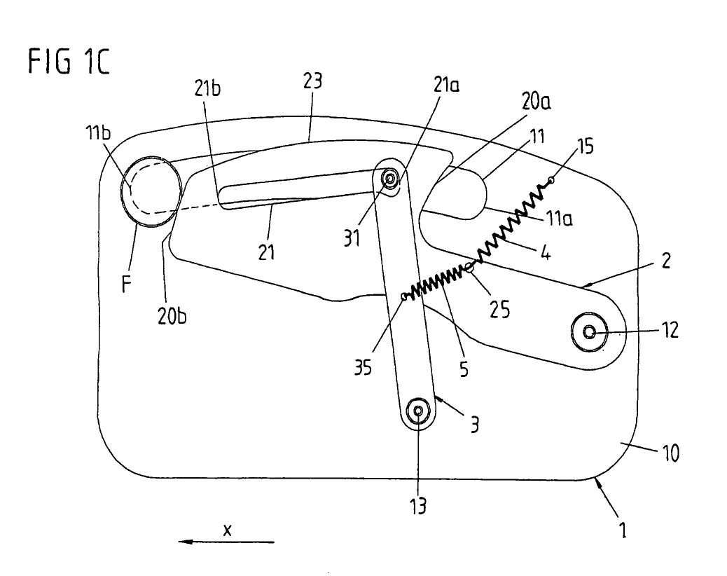

FIG. 1a shows a first illustrative embodiment of a guide device for guiding and locking a guide section F of an adjuster lever or of another adjuster element, which guide device is disposed on a base plate 1.

The base plate 1 has in its plate-shaped basic element 10 a longitudinally extended guide link 11, in which an adjuster lever (not represented in detail) is guided with a guide section F and which extends with slight curvature in the vehicle longitudinal direction x between a first end 11a and a second end 11b, the two ends 11a, 11b of the guide link 11 respectively defining an adjustment position of the guide section F and thus of the assigned adjuster lever.

The locking of the guide section F in each of the two adjustment positions, i.e. either in the region of the first end 11a or in the region of the second end 11b of the guide link 11, is attended to by a locking element in the form of a locking lever 2, which is attached to the base plate 1 pivotably about an axis 12 and which, in its locking position represented in FIG. 1a, is arranged in such a way that a first locking section 20a of the locking lever 2 lies opposite the first end 11a of the guide link 11 and a second locking section 20b of the locking lever 2 lies opposite the second end 11b of the guide link 11. The guide section F of an adjuster lever can here be clamped between the respective locking section 20a, 20b of the locking lever 2 and the respectively opposite end 11a and 11b of the guide link 11, so that the guide section F is blocked in the respective adjustment position and the locking lever is thus detained.

The locking lever 2 is elastically pretensioned in the direction of the locking position by means of an elastic element (restoring means) in the form of a tension spring 4 configured as a helical spring, which tension spring is suspended by one end from a fastening point 15 on the base plate 1 and is suspended by the other end from a fastening point 25 on the locking lever 2.

Under the action of the tension spring 4, the locking lever 2 tends always to assume its locking position in which it blocks the guide pin F at one or other end 11a, 11b of the guide link 11 (in accordance, respectively, with an adjustment position of the guide section F). In the state shown in FIG. 1a, the guide section F is blocked in a first adjustment position, in that it is accommodated and clamped between the first end 11a of the guide link 11 and the opposite first locking section 20a of the locking lever 2.

The locking lever 2 is here detained in its locking position by means of a further, secondary locking lever 3, which is attached to the base plate 1 pivotably about a swivel axis 13 and cooperates with the locking lever 2 via a link guide 21, 31. The secondary locking lever 3 is pretensioned by means of an elastic element (restoring means) in the form of a further tension spring 5 configured as a helical spring, which tension spring is attached by one end to a fastening point 25 on the locking lever 2 and by the other end to a locking point 35 on the secondary locking lever 3, in the direction of the state in which it detains the (primary) locking lever 2 in the locking state. The secondary locking lever 3 here bears against one end 21a of the corresponding connecting link 21 with a guide element 31 which engages in the connecting link 21 of the primary locking lever 2.

Ultimately, the guide section F of the adjuster lever, in the state shown in FIG. 1a, is detained in a first adjustment position, and in this adjustment position is clamped between one end 11a of the guide link 11 provided on the base plate 1 and an opposite locking section 20a of the locking lever 2 located in its locking position and is thus blocked in a play-free and rattle-free manner.

In order to be able to move a seat part, adjustable by means of the adjuster lever, in a direction x, the blocking of the guide section F of the adjuster lever must be released, thereby allowing a swivel motion of the corresponding adjuster lever, with a simultaneous movement of its guide section F along the guide link 11 to the other end 11b thereof. This can be achieved in a simple manner by the secondary locking lever 3 being pivoted (counterclockwise) in such a way about its swivel axis 13 that its guide element 31 moves in the assigned locking link 21 of the locking lever 2 from one end 21a in the direction of the other end 21b, to be precise counter to the action of the tension spring 5 assigned to the secondary locking lever 3. This can be done either manually, by action upon a corresponding control element coupled to the secondary locking lever 3, or by servo means, by a drive motor which cooperates with the secondary locking lever 3. As a result of the herewith associated action of the secondary locking lever 3 upon the primary locking lever 2 via the guide element 31, and the assigned locking guide link 21, the primary locking lever 2 is pivoted (likewise counterclockwise) in such a way about its swivel axis 12 that it disengages from the guide section F and releases the guide link 11, provided on the base plate 1, for a movement of the guide section F, compare FIG. 1b. The guide section F can then be moved along the assigned guide link 11 (where appropriate, sliding along an upper edge 23 of the locking lever 2) from the first end 11a in the direction of the second end 11b, whereby a corresponding swivel motion of the assigned locking lever is enabled. As a result, the seat part coupled to the adjuster lever is moved in a direction x in the manner previously described.

When the second adjustment position is reached, in accordance with a contact of the guide section F of the corresponding adjuster lever against the front, second end 11b of the guide link 11, the locking lever 2, under the action of the assigned restoring means in the form of a tension spring 4, can return into the locking position represented in FIG. 1c, the guide section F then being accommodated between the front end 11b of the guide link 11 and the assigned, opposite locking section 20b of the locking lever 2 and thus being blocked in the corresponding adjustment position. For this purpose, it is merely necessary to release the secondary locking lever 3, so that this no longer opposes a return motion of the primary locking lever 2 into the locking position and the tension spring 4 acting upon the primary locking lever 2 can bring about the described return of the locking lever 2 into the locking position.

At the same time, the secondary locking lever 3 also, under the action of the assigned restoring means in the form of a tension spring 5, is transferred back into the state in which it detains the primary locking lever 2 in its locking position. For this purpose, the secondary locking lever 3 moves under the action of the assigned compression spring 5 in the connecting link 21 provided on the primary locking lever 2, with the guide element 31 which engages there, in the direction of the first end 21a thereof, where the guide element 31 acts as a stop preventing the primary locking lever 2 from being pivoted out of the locking position.

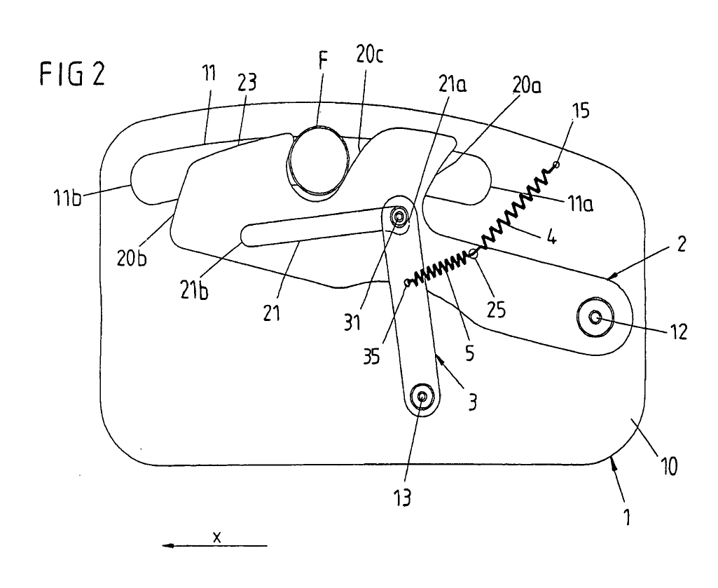

It ultimately becomes clear with reference to FIG. 2a to 2c that, with only one locking element in the form of a locking lever 2, the guide section F, and hence also the adjuster lever connected to the guide section, can be locked in two different adjustment positions, in each of the two adjustment positions one of two lateral locking sections 20a, 20b of the locking lever 2 blocking the guide section F in the guide link 11 of the base plate 1 in its respective adjustment position. This is achieved by means of just one single locking element in the form of a locking lever 2, which is movable to and fro between a release position and a locking position and is here elastically pretensioned in the direction of the locking position and can be detained in this latter position by means of a secondary locking lever 3.

FIG. 2 shows a refinement from FIG. 2a to 2b, the difference consisting in the fact that the locking lever 2 has between the two locking sections 20a, 20b a recess which serves as a third locking section 20c and in which the guide section F of an adjuster lever can engage when it is located in the middle region of the assigned guide link 11 between the two ends 11a, 11b thereof and the locking lever 2 is disposed in the locking position, as represented in FIG. 2. This allows the guide section F, and hence the assigned locking lever, to be locked in a third adjustment position lying between the two adjustment positions defined by the ends 11a, 11b of the guide link 11.

For all adjustment positions, the edges of the locking sections 20a, 20b, 20c against which the guide section F respectively bears and which thus act as stops for blocking the guide section F in the respective adjustment position are spatially aligned in such a way that the action of the guide section F upon the respective locking section 20a, 20b or 20c in the direction of extent of the guide link 11 does not tend to pivot the locking lever 2 out of its locking position into the release position. In other words, the guide section F, in the respective adjustment position, acts upon the respectively assigned locking section 20a, 20b or 20c of the locking lever 2 in such a way that this tends to remain in the locking position (self-retaining locking).

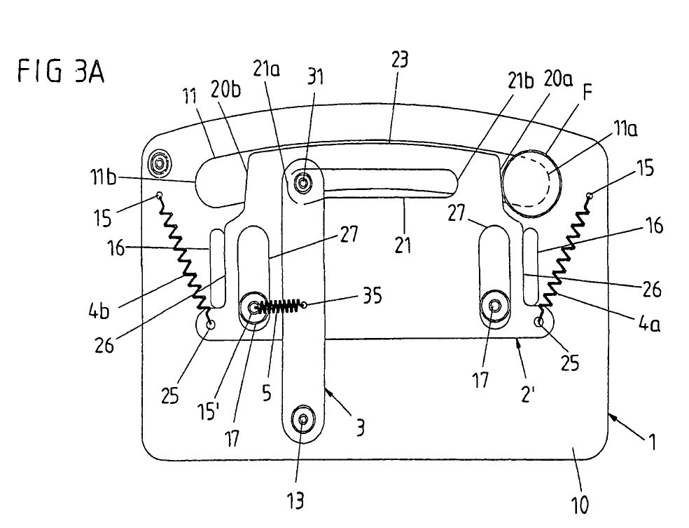

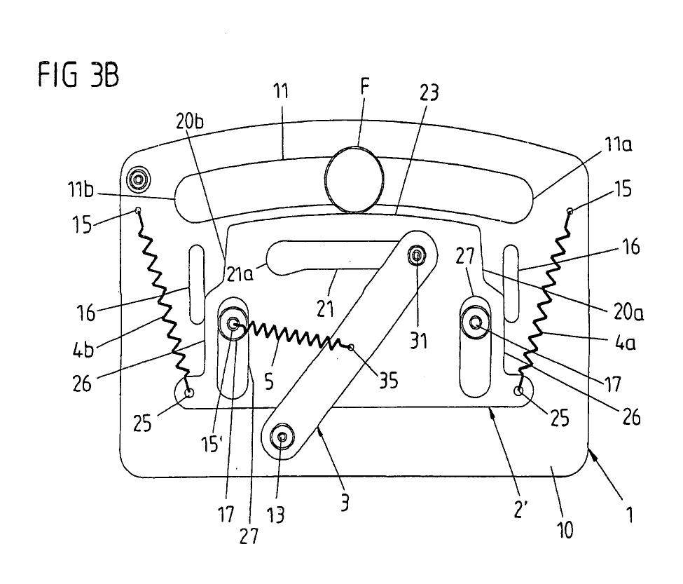

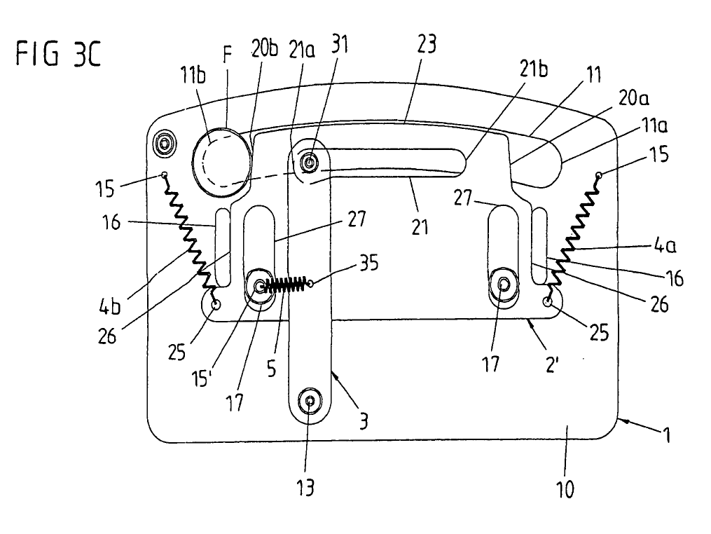

FIG. 3a shows a modification of the arrangement from FIG. 1a, the basic difference consisting in the fact that a locking element in the form of a displaceable locking part 2′ serves (in place of a locking lever) to lock the guide section F in a connecting link 11 provided in the basic element 10 of a base plate 1.

The longitudinally displaceable locking part 2′ is guided by means of guide webs 16 and guide pins 17 provided on the base plate 1, and by means of assigned guide faces 26 and slots 27 of the displaceable locking part 2′, in a longitudinally displaceable and tilt-proof manner on the basic element 10 of the base plate 1. In this case, it is pretensioned in the direction of a locking position by elastic means in the form of two tension springs 4a, 4b configured as helical springs, which tension springs are respectively suspended by one end from a fastening point 15 on the base plate 1 and by the other end from a fastening point 25 on the locking part 2′. In this locking position, two lateral locking sections 20a, 20b of the locking part 2′ lie respectively in such a way opposite one end 11a and 11b of the guide link 11 provided in the base plate 1 that the guide section F can respectively be received there and can be blocked, by clamping, in a play-free and rattle-free manner.

FIG. 3a here shows the guide device in a state in which the guide section F is accommodated between a first end 11a of the guide link 11 and an opposite first locking section 20a of the locking part 2′, so that the associated adjuster lever is locked in the corresponding adjustment position.

Here too, to the primary locking element formed by the longitudinally displaceable locking part 2′ there is assigned a secondary locking element in the form of a secondary locking lever 3 which is pivotable about an axis 13 provided on the base plate 1 and which, with a guide element 31 lying opposite the swivel axis 13, is guided in a locking link 21 of the locking part 2′. The secondary locking lever 3 is pretensioned, in the direction of a state in which it detains the longitudinally displaceable locking part 2′ in its locking position, by elastic means in the form of a tension spring 5 configured as a helical spring, which tension spring is suspended, on one hand, from a fastening point 15, fixed on the base plate and, on the other hand, from a fastening point 35 provided on the secondary locking lever 3. The guide element 31 of the secondary locking lever 3 here bears against one end 21a of the connecting link 21 provided in the longitudinally displaceable locking part 2′ and acts there as a stop preventing the locking part 2′ from being moved out of the locking position.

In order to be able to move the guide section F out of the adjustment position shown in FIG. 3a, in which it is disposed at the first end 11a of the assigned guide link 11, into the second adjustment position next to the second end 11b of the guide link 11, the secondary locking lever 3 must be pivoted (clockwise) counter to the action of the assigned restoring means (tension spring 5) in such a way the guide element 31 thereof moves in the direction of the other end 21b of the slot-like locking link 21 provided in the longitudinally displaceable adjuster part 2′. For this purpose, the secondary locking lever 3 is coupled to an assigned actuating device, for example in the form of a manual control element or in the form of a servo drive.

The pivoting of the secondary locking lever 3, which thus serves, at the same time, as an actuating device, causes the longitudinally displaceable locking part 2′, as represented in FIG. 3b, to be displaced in such a way that it no longer covers the guide link 11 provided in the base plate 1. The guide section F can then be moved from one end 11a of the guide link 11 in the direction of the other end 11b thereof, it being able to slide along an upper edge 23 of the longitudinally displaceable locking part 2′.

After the second end 11b of the guide link 11 has been reached, in accordance with the second adjustment position of the assigned adjuster lever, the guide section F can then readily be locked in the newly reached position by termination of the actuation of the secondary locking lever 3. Under the action of the assigned tension springs 4 and 5 acting as restoring means, according to FIG. 3c the longitudinally displaceable locking part 2′ and the secondary locking lever 3 then return respectively into the position in which they bring about a locking of the guide section F in the second adjustment position and, at the same time, a detention of the longitudinally displaceable locking part 2′ in the corresponding locking position.

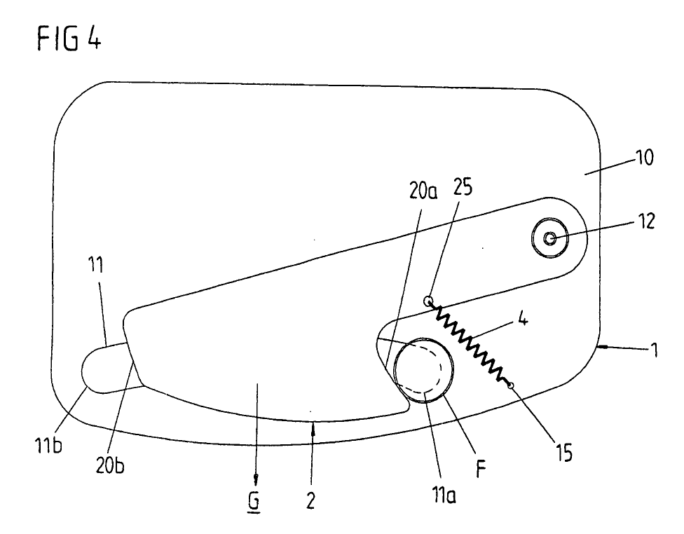

FIG. 4 shows a further modification of the arrangement from FIG. 2a to 2b, the basic difference consisting in the fact that the locking lever 2, in its locking position represented in FIG. 4, in which it can detain the guide section F in the respective adjustment position with one or other locking section 20a, 20b, is held, apart from by the elastic pretensioning of a restoring spring 4, also by means of gravitational forces G. In other words, in this illustrative embodiment the locking lever 2 is arranged such that, in the locking position, the gravitational forces G acting upon the locking lever 2 act in the direction of a maintenance of the locking position. If the weight of the locking lever 2 is sufficiently great, an additional, secondary locking element for detaining the locking lever 2 in its locking position can in this case be relinquished.

1-30. (canceled)

31. A guide device for guiding an adjuster element on an adjuster device for motor vehicles, comprising
a guide track, along which the adjuster element can be moved,
a guide section of the adjuster element, via which the adjuster element is guided in the guide track, and
locking means for locking the guide section in the guide track in at least two mutually spaced adjustment positions,
wherein the locking means comprise a movably mounted locking element having at least two mutually spaced locking sections, and in that the locking element can be brought into a locking position in which it, with one locking section, can block the guide section in a first adjustment position and, with the other locking section, can block the guide section in a second adjustment position.

32. The guide device of claim 31, wherein the locking element can be moved to and fro between a release position and a locking position, wherein, in the release position, it permits a movement of the guide section in the guide track and, in the locking position, blocks the guide section in the guide track in its respective adjustment position.

33. The guide device of claim 31 or 32, wherein the locking element is formed by a pivotably mounted locking lever.

34. The guide device of claim 31 or 32, wherein the locking element is formed by a locking part which is mounted in a longitudinally displaceable manner.

35. The guide device of claim 31, wherein the locking element is elastically pretensioned in the direction of the locking position.

36. The guide device of claim 32, wherein the locking element can be brought into the release position counter to the action of the elastic pretensioning.

37. The guide device of claim 31, wherein to the locking element there is assigned a secondary locking element, with which the locking element can be detained in the locking position.

38. The guide device of claim 37, wherein the secondary locking element is elastically pretensioned in the direction of a position in which it detains the locking element in the locking position.

39. The guide device of claim 38, wherein the secondary locking element can be moved counter to the elastic pretensioning out of the position in which it detains the locking element in the locking position.

40. The guide device of claim 37, wherein the secondary locking element is coupled to the locking element in such a way that, through movement of the secondary locking element out of the position in which it detains the locking element, the locking element is brought into the release position.

41. The guide device of claim 37, wherein the secondary locking element cooperates with the locking element via a link guide.

42. The guide device of claim 41, wherein for the tolerance equalization with respect to the subassemblies involved in the locking of the guide section and for the play-free locking of the guide section, the secondary locking element is engaged with the locking element in the locking position in a play-bound manner.

43. The guide device of claim 37, wherein the secondary locking element is formed by a pivotably mounted locking lever.

44. The guide device of claim 31, wherein the locking element is arranged in such a way that, at least in the locking position, the weight force acting upon the locking acts in the direction of a maintenance of the locking position.

45. The guide device of claim 31, wherein the guide track is formed by a guide link.

46. The guide device of claim 45, wherein the guide section of the adjuster element is formed by a guide pin which engages in the guide link.

47. The guide device of claim 31, wherein the two adjustment positions are formed by two end positions of the guide section in the guide track.

48. The guide device of claim 45, wherein in each of the two adjustment positions the guide section is clamped between a lateral rim of the guide link and a locking section of the locking element.

49. The guide device of claim 31, wherein the guide section, in each of the adjustment positions, respectively acts upon the assigned locking section of the locking element in such a way that the locking element tends to remain in the locking position.

50. The guide device of claim 38, wherein the locking section is configured as an eccentric.

51. The guide device of claim 31, wherein two locking sections of the locking element are formed by lateral end sections of the locking element.

52. The guide device of claim 31, wherein the locking element has at least three locking sections, which serve to lock the guide section of the adjuster element in a respective adjustment position.

53. The guide device of claim 52, wherein at least one locking section is formed by a recess in the locking element.

54. The guide device of claim 53, wherein the recess forming the locking section has a tapered region for the play-free reception of the guide section.

55. The guide device of claim 52, wherein one adjustment position corresponds to a position of the guide section between the two ends of the guide track.

56. The guide device of claim 31, wherein the locking element has a contact contour, which, during movement of the guide section in the guide track between two adjustment positions, is supported in sliding arrangement against the guide section, so that the locking element is held in a release position in which it does not block the guide section.

57. The guide device of claim 56, wherein the locking element automatically detains the guide section, under the action of at least one elastic element, when one of the adjustment positions is reached.

58. The guide device of claim 31, wherein it serves to guide an adjuster element of an adjuster device for motor vehicle seats.

59. The guide device of claim 58, wherein the adjuster device serves to adjust a seat support, a backrest or a headrest of a motor vehicle seat.

60. A seat adjuster device for motor vehicles, comprising a seat part to be adjusted and an adjuster element for adjusting the position of the seat part, wherein a guide device as claimed in claim 31, is guided by means of the adjuster element.
